(19) United States
(12) Patent Application Publication
(10) Pub. No.: US 2023/0342285 A1
(43) Pub. Date: Oct. 26, 2023

(54) Multiplayer Debugger

(71) Applicant: Replit, Inc., San Francisco, CA (US)

(72) Inventors: Tyler Jacob Angert, New York, NY (US); Luis Hector Chavez Freire, Mountain View, CA (US); Oleksandr Kotliarskyi, Seattle, WA (US)

(21) Appl. No.: 18/150,049

(22) Filed: Jan. 4, 2023

Related U.S. Application Data
(60) Provisional application No. 63/363,453, filed on Apr. 22, 2022.

(51) Int. Cl. G06F 11/36

(52) U.S. Cl. CPC G06F 11/3664; G06F 11/3696

(57) ABSTRACT

A system for a multiplayer debugger includes a computer program, a debugger module, and a debugger multiplexer. The debugger multiplexer initiates a multiplayer debugger session for the computer program, wherein the multiplayer debugger session supports a plurality of client devices, receives from a first client device of the plurality of client devices, a debugger operation, and transmits the debugger operation to the debugger module. An updated debugger state is determined in accordance with the debugger operation, and the updated debugger state is transmitted to a remainder of the plurality of client devices.

### BACKGROUND

Software development often requires developing or creating software programs in the form of computer code that can be very lengthy and complex. As such, understanding a computer program when viewing the code can be difficult, particularly for novice programmers. The difficulty in understanding computer programs is particularly problematic when trying to identify discrepancies or errors that affect operation of the computer program, such as debugging the code. Current technology allows a user to run a debugger software tool to enable a programmer to monitor the execution of a program, stop the program, start the program, set breakpoints, set and read values, and the like. However, debugging tools are limited to a singular instance of a program on a singular machine.

### BRIEF DESCRIPTION OF THE DRAWINGS

For a detailed description of various examples, reference will now be made to the accompanying drawings in which:

FIG. 1 shows a network diagram of an environment in which various embodiments described herein may be practiced;

FIG. 2 shows a flowchart of a technique for a multiplayer debugger, according to one or more embodiments;

FIG. 3 shows a network diagram of an environment in which multiple sessions of a multiplayer debugger may be deployed, according to one or more embodiments;

FIG. 4 shows a flowchart of a technique for a multiplayer debugger, according to one or more embodiments;

FIG. 5 shows an example diagram of screenshots of clients utilizing a multiplayer debugger according to one or more embodiments; and

FIG. 6 shows an example of a hardware system for implementation of the multiplayer debugger in accordance with the disclosed embodiments.

### DETAILED DESCRIPTION

The following description relates to technical improvements to the debugging experience to provide a technique and system for understanding what and why computer code is performing across space and/or time. In particular, the following description relates to a system and technique for an improved computer code debugger and debugging experience to provide collaborative debugging across multiple devices. In some embodiments, techniques described herein provide a collaborative technique to debugging so that users can better understand what their code is doing while an associated program is running. The debugging process may be provided in an interactive fashion and within a collaborative workspace. As such, the debugging process may be a multiplayer debugger in which users can collaboratively better understand what computer code is doing while running, and be able to debug the program in a collaborative fashion.

Techniques described herein improve traditional program debugging techniques by enabling multiple users on different devices to collaboratively debug a computer program in real time. As such, in some embodiments, users on different devices can both perform debugging operations on a single program such that the debugging operations are visible on all devices in the session. Improvements to the debugging process allow for multiple debugging sessions to run in which various devices can subscribe to each session.

In the following description, numerous specific details are set forth to provide a thorough understanding of the various techniques. As part of this description, some of the drawings represent structures and devices in block diagram form. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components. It should be understood that the language used in this disclosure has been principally selected for readability and instructional purposes, and may not have been selected to delineate or circumscribe the disclosed subject matter. As such, the various processes may be performed by alternate components than the ones described.

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

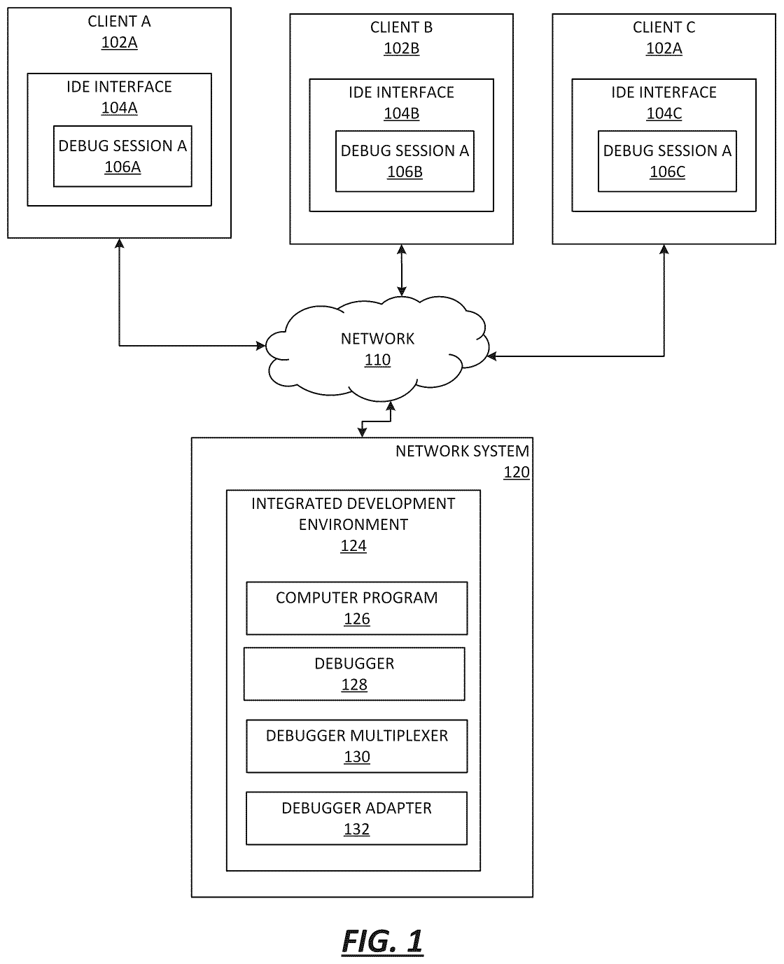

FIG. 1 shows a network diagram of an environment in which various embodiments described herein may be practiced. Techniques described herein provide a system and method for a multiplayer debugger. The network diagram includes multiple client devices, such as client A 102A, client B 102B, and client C 102C, communicably connected to a network system 120 across a network 110. Although a particular representation of components and modules is presented, it should be understood that in some embodiments, the various components and modules may be differently distributed among the devices picture, or across additional devices not shown.

Clients 102A, 102B, and 102C may each be computing devices from which an integrated development environment (IDE) is accessed. An IDE is computer software that provides tools used by programmers to develop software. The IDE may include, for example, a source code editor, debugger, and other programming tools. The IDE 124 may be hosted on one or more network devices of network system 120. The IDE 124 may be accessed across the network 110 via an IDE interface from each client, such as IDE interface 104A, IDE interface 104B, and IDE interface 104C. The IDE interface may be an application running on the corresponding client device, or may be accessed from a remote device such as a network device via a web browser, or the like. The IDE interface of each client device may provide access to a common debug session, as shown by the instance of debug session A 106A on client device 102A, the instance of debug session A 106B on client device 102B, and by the instance of debug session A 106C on client device 102C.

The IDE 124 hosted on network system 120 may include a computer program 126, which may be the focus of a development session by one or more programmers on the client devices 102A, 102B, and 102C. The IDE 124 may additionally include a debugger 128. Debugger 128 is a program that facilitates with the detection and correction of errors in other computer programs. In addition, the debugger can be used as a tool to track the operation of other computer programs. To that end, the debugger 128 may be a program which provides a capability to monitor the execution of a program, stop the program, start the program, set breakpoints, set and read values, and the like. The debugger 128 includes logic such that it is capable of communicating with the operation system to cause the program to perform debugging actions, such as pause, continue, modify, inspect memory, and the like.

According to some embodiments, the IDE 124 may include a debugger multiplexer 130. The debugger multiplexer may be configured to start a computer program, such as computer program 126 under a debugger, such as debugger 128. In some embodiments, the IDE 124 may support multiple programming languages. As such, the debugger multiplexer may determine program characteristics required to initialize and support the program 126 and the debugger 128, such as communication architecture, program interface, and the like. For example, some debugger implementations expect the TTY to be allocated in a different window. As another example, some debugger implementations require a TCP socket for communication. The debugger multiplexer 130 can communicate directly with the debugger 128 and can handle an arbitrary number of devices communicably connected to it. As such, the debugger multiplexer 130 acts as an abstraction layer between the debugger and the multiple devices. In some embodiments, the debugger multiplexer 130 includes a session manager that is configured to create and terminate debugger multiplexer sessions, route messages to and from clients to the correct sessions. The debugger multiplexer 130 receives messages from the clients and negotiates with the debugger adapter 132 about the current state of the program. The debugger adapter 132 performs a language-independent and/or debugger implementation abstraction. Each instance of the debugger multiplexer 130 may act as a debugger proxy. The debugger multiplexer 130 may forward program status data, for example in the form of the stdio of the computer program, to the debugger. The IDE may include an adapter program 132 configured to provide multilanguage functionality by abstracting debugger operations. The debugger multiplexer 130 may transmit the program status data of the adapter program to the debugger, for example over a localhost TCP socket.

According to some embodiments, messages may be transmitted between the adapter and the multiplexer indicating a current state of the program. The multiplexer processes those messages, and has a logic to confirm that each client has a consistent view of the program being debugged. As such, the messages from the adapter program may or may not be sent to the clients depending on internal logic and decisions by the multiplexer. Similarly, if a multiplexer receives a debugger operation from a client within a debugger session, then the multiplexer manages communication of those messages.

The debugger multiplexer 130 also manages state information for a debugging session in order to synchronize the debugging session for multiple users. Thus, two users on different client devices can view the same state of the console at the same time. Further, two users on different client devices can each drive the debugger in a single session, while maintaining a consistent view across devices. Accordingly, a live interactive multiplayer debugger is provided which supports multiple users collaborating in a single debugger session.

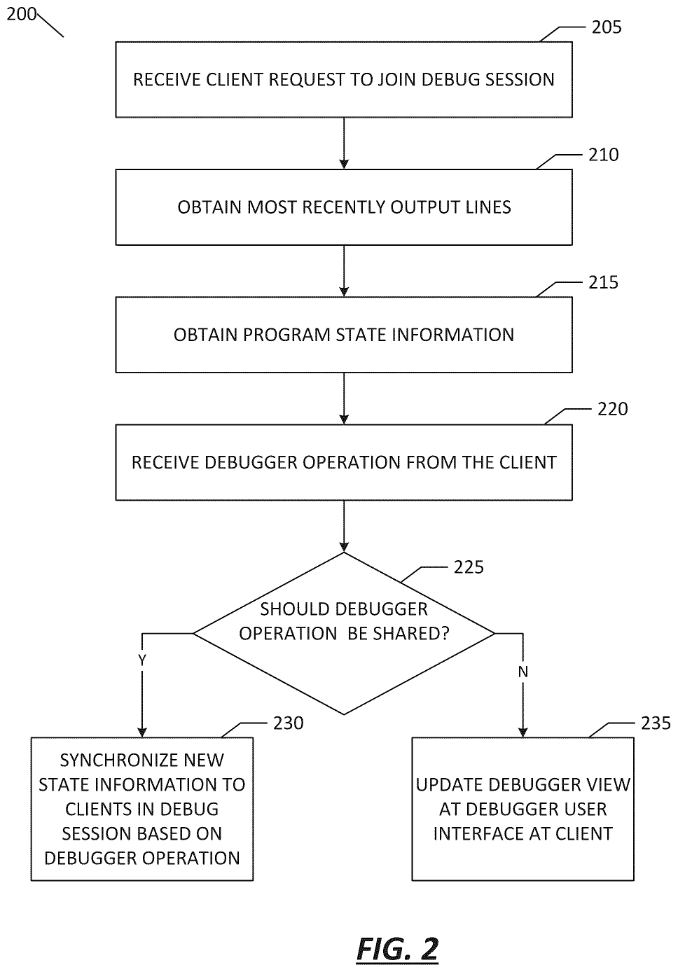

FIG. 2 shows a flowchart of a technique for a multiplayer debugger, according to one or more embodiments. It should be understood that the particular flow of the flow diagram is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components for purposes of explanation, but should not be considered limited to those components.

The flowchart 200 begins at block 205 where a client request is received to join the debug session. In some embodiments, the client request may be received via the IDE interface 104. In some embodiment, a user may choose to run their program normally, with a multiplayer debugger attached. When the multiplayer debugger is enabled, the interface will show the debugging tools available.

At block 210, most recently output lines from the debugger are obtained. By receiving the most recent output lines, the client device can provide a current view of the debugging session. In addition, at block 215, program state information is obtained. The state information may include, for example, breakpoints, watched variables, running/stopped state, and the like. In some embodiments, this initial handshake may include the client receiving, from the server, the totality of the current state of execution so that the client can catch up to the current state of the session.

The flowchart 200 continues at block 220 where a debugger operation is received from one of the clients. Debugger operations may include, for example, set breakpoints, set and read values, and the like. In some embodiments, a user can operate an instance of the debugger on a local client, for example through a local user interface. The local user interface may be used to receive input by a user for debugger operations. At block 225 a determination is made regarding whether the debugger operation should be shared with other clients in the session. In some embodiments, certain interactions with the debugger interface may or may not be broadcast. For example, if an operation does not affect a state of the program, the operation may only be performed on the local instance. Examples of such operations include pure inspection queries, such as obtaining the list of executing threads and the stack trace. Thus, a determination may be made as to whether the debugger operation satisfies a share criterion.

If at block 225 a determination is made that the debugger operation should be shared with other clients in the debugger session, then the flowchart concludes at block 230 and the new state information is synchronized to other clients in the debug session. According to some embodiments, the debugger interface on the client devices may maintain a synchronized view, such that any action taken by any user will be visible to all other er users. As such, replies and events from the debugger will be broadcast to all members of the session. Further, any user can mutate an execution state. According to some embodiments, the synchronization is performed by the debugger multiplexer acting as a proxy for the session, which may provide the broadcasts, maintain state information, and the like.

Returning to block 225, if a determination is made that the debugger operation should not be shared, then the flowchart concludes at block 235 and the debugger view is updated at the local client from which the debugger operation was received. As described above, the debugger operation may not be shared in accordance with a determination that the debugger operation does not satisfy a share criterion. The debugger operation may not satisfy the share criterion, for example, if the debugger operation does not augment the state of the program, or includes pure inspection queries.

According to one or more embodiments, the IDE may be provided for particular communities and contexts, such as educational settings, work groups, smaller programming communities and the like. As an example, teachers may be able to enter a debugging session with students and direct the students to find a bug. As another example, students can ask for help from a teacher using the multiplayer debugger. As yet another example, hobbyists that are collaborating in a project can diagnose an error in their program and collaboratively understand what the error is and how to fix it. Further, a development team can record an execution of a program and help onboard new members regarding how the program works by collaboratively viewing and walking through the replay of execution.

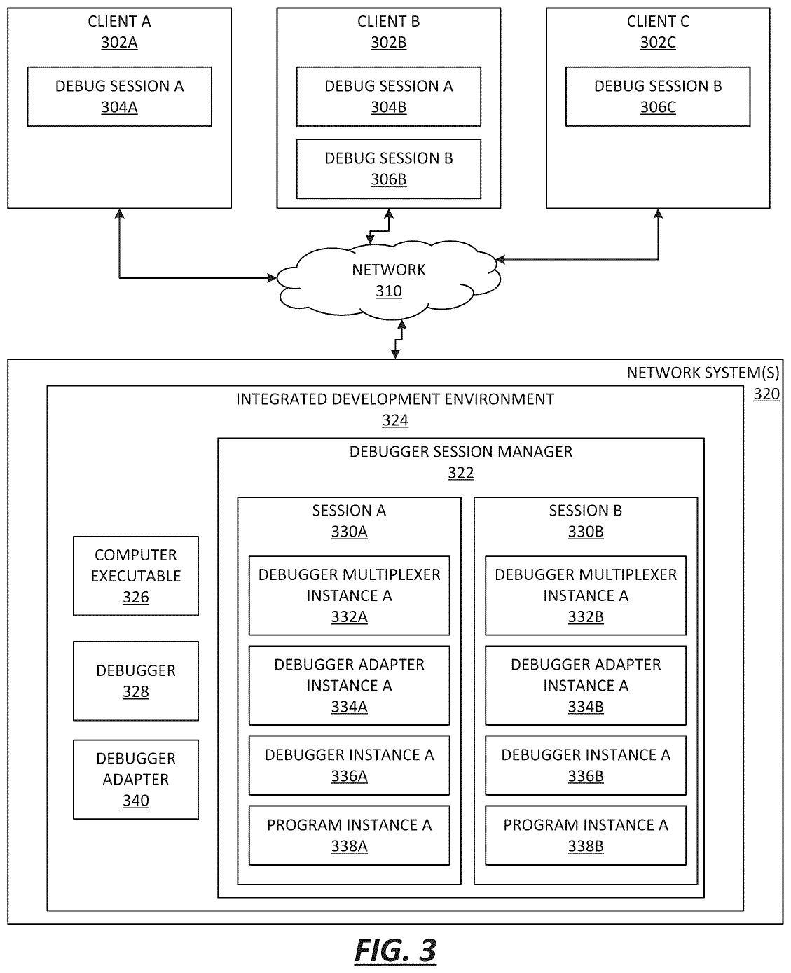

In some embodiments, multiple debug sessions may be created per program. As an example, a set of users may be participating in a primary debug session through the debug multiplexer. According to one or more embodiments, a second session may be initiated by any one of the users. FIG. 3 shows a network diagram of an environment in which multiple sessions of a multiplayer debugger may be deployed, according to one or more embodiments. Similar to FIG. 1 described above, the network diagram 300 includes multiple client devices, such as client A 302A, client B 302B, and client C 302C, communicably connected to a network system 320 across a network 310. Although a particular representation of components and modules is presented, it should be understood that in some embodiments, the various components and modules may be differently distributed.

Clients 302A, 302B, and 302C may each be computing devices from which an IDE is accessed. The IDE 324 may be hosted on one or more network devices of network system 320. The IDE 324 may be accessed across the network 310 via an IDE interface from each client. The IDE interface may be an application running on the corresponding client device, may be accessed via a web browser, or the like. The IDE interface of each client device may provide access to one or more common debug sessions. As shown, client A 302A is active in a Debug Session A 304A. Client B 302B is also active in Debug Session A as shown by instance 304B, and is also active in Debug Session B as shown by instance 306B. Further, client device 302C is also active in Debug Session B as shown by instance 306C.

The IDE 324 hosted on network system 320 may include an executable for a computer program 326, which may be the focus of a development session by one or more programmers on the client devices 302A, 302B, and 302C. That is, the Debug Session A and Debug Session B may both be directed to the computer program executable 326. Notably, each session includes multiple client devices participating in the session. The IDE 324 may additionally include a debugger 328. The debugger 128 may be a program which provides a capability to monitor the execution of a program, stop the program, start the program, set breakpoints, set and read values, and the like. The IDE 324 may additionally include a debugger adapter 340, which may be configured to provide an abstraction for the debugger 328 such that each user may perform debugging operations on an instance of the computer executable 326.

According to some embodiments, the IDE 324 may include a debugger session manager 322, which may be configured to create and terminate debugger multiplexer sessions, such as session A 330A and session B 330B. Each session may be associated with an instance of the debugger multiplexer, debugger adapter, debugger, and an instance of the computer executable. The debugger multiplexer, such as debugger multiplexer instance A 332A and debugger multiplexer instance B 332B may be configured to start a computer program, such as program instance A 334A and program instance B 334B, respectively. The debugger multiplexer 332A and 332B also manages state information for each of the debugging session in order to synchronize the debugging session for multiple users in each session. In addition, the debugger adapter instances 334A and 334B are configured to provide an abstraction for the instances of the debugger 336A and 336B such that each user may perform debugging operations using the debugger 336A and 336B on the corresponding program instance 338A or 338B. Thus, two users on different client devices can view the same state of the console at the same time. Further, two users on different client devices can each drive the debugger in a single session, while maintaining a consistent view across devices. Accordingly, a live interactive multiplayer debugger is provided which supports multiple users collaborating in a single debugger session, and the technique is capable of supporting multiple collaborative debugger sessions for a single program.

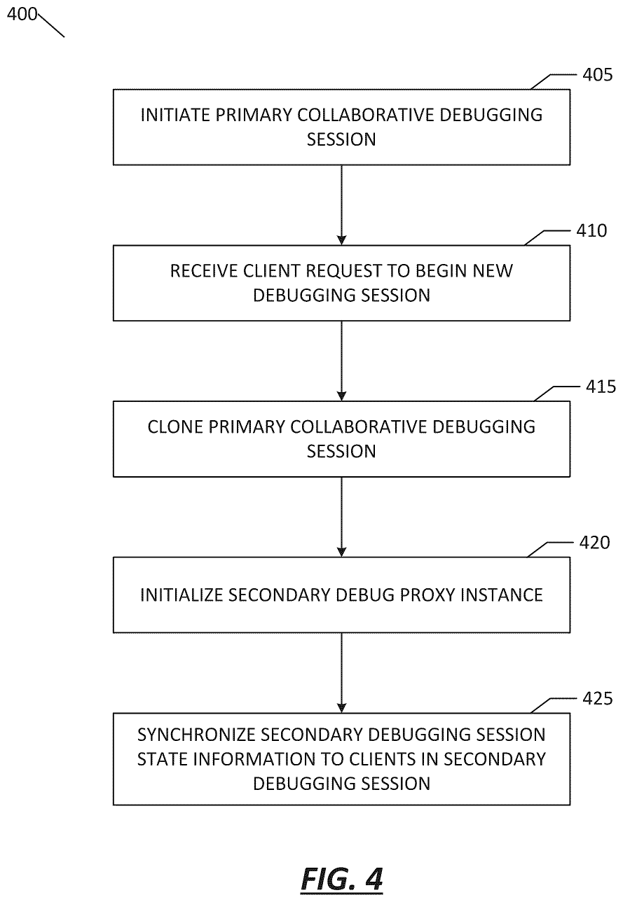

FIG. 4 shows a flowchart of a technique for a multiplayer debugger, according to one or more embodiments. In particular, FIG. 4 depicts a flowchart of a technique for initializing a second collaborative session for a single program. It should be understood that the particular flow of the flow diagram is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components for purposes of explanation, but should not be considered limited to those components.

The flowchart 400 begins at block 405 where a client request is received to join the debug session. In some embodiments, the client request may be received via the IDE interface 304. In some embodiment, a user may choose to run their program normally, with a multiplayer debugger attached. When the multiplayer debugger is enabled, the interface will show the debugging tools available.

At block 410, a client request is received to begin a new debug session for the same computer program as the primary collaborative debugging session. The client request may be received through the IDE interface of the client device.

The flowchart continues at block 415, where the primary collaborative debugging session is cloned. For example, by cloning the primary debug session from a current state such that future debug operations may differ between the primary debug session and the secondary debug session. Further, in some embodiments, both debug sessions may be made available to programmers such that a user can subscribe to a particular session. As such, a user can cooperatively debug the program within whichever session the user is subscribed to. In some embodiments, each session is associated with a unique debug proxy. As such, at block 420, a proxy instance is initialized for the secondary session.

The flowchart concludes at block 425 where the secondary debug session state information is synchronized to clients in the secondary debug session. According to some embodiments, the synchronization is performed by a proxy for the session, which may provide the broadcasts, maintain state information, and the like. According to some embodiments, the debugger interface on the client devices may maintain a synchronized view, such that any action taken by any user will be visible to all other users. As such, replies and events from the debugger will be broadcast to all members of the session.

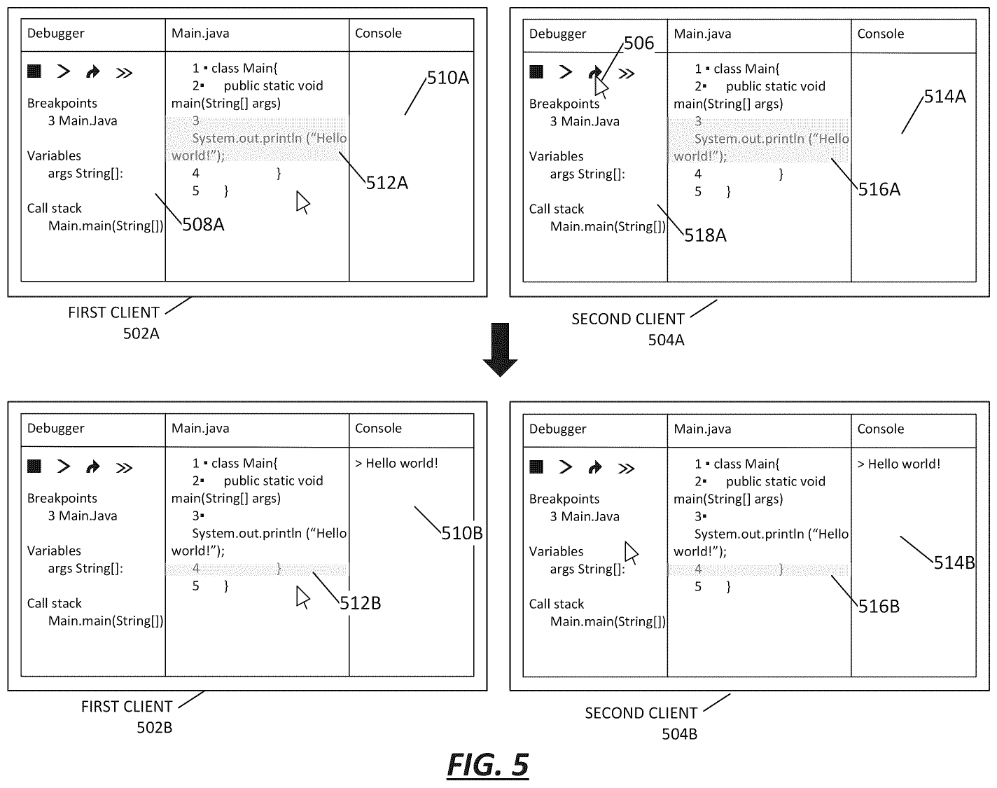

Turning to FIG. 5, an example set of user interfaces are depicted. The example user interfaces includes, at a first time, a first client 502A, and a second client 504A in a common collaborative debugging session. As shown, at the first time, the debugging session is in a first state, shown by line 3 of the program being the currently active line in the program at 512A and 516A. In addition, the console 510A and 514A are shown as blank. For purposes of this example, a cursor is in a neutral position on the first client 502A. However, in the second client 504A, the cursor is selecting a next step in the program, as shown at 506.

According to one or more embodiments, the user interface of the debug session at a particular environment is enhanced for multiplayer debugging by including components to support usability across users. In some embodiments, a visual indication may be presented in a consistent manner on each client in the session to indicate a processing state of the program. The visual indication may be presented in a consistent manner to indicate state information for the program. For example, as shown by 512A and 516A, line 3 is highlighted on each client to indicate that line 3 is the currently active line. In other embodiments, a cursor, such as a blinking cursor, may be presented at a current point of execution in the program. According to one or more embodiments, the debugger multiplexer may track such state information and share state information across clients in the session. Further, the clients can present consistent views of the program in accordance with the state information. As another example, lines that have been run may be demarcated or otherwise presented in association with a visual indication, as shown by the notation in front of lines 1-3.

As another example, usability of the user interface can be enhanced for a multiplayer session by selectively presenting data in an information panel, such as information panel 508A and 518A. According to one or more embodiments, the multiplexer debugger may include logic to select and display the most relevant data in the information panel. As an example, the information panel may be configured to display a hierarchy of variable values. A portion of the hierarchy may be displayed based on a selection by the multiplexer debugger. The multiplexer debugger may determine most relevant variables or other data and present the information in the information panel. According to one or more embodiments, relevance of the information may be determined based on one or more parameters, such as most recently updated variables, most recently used variables, and the like.

In response to a user with a client device selecting the next step in the program, a change in presentation in the UI occurs. As such, at 502B, the first client shows, without further user input, the current line of the program is now line 4, as shown at 512B. Further, the Console now reads, “Hello world!” Similarly, because the operation was received at the second client 504, in the user interface of the second client 504B, the current line of the program is also shown as line 4 at 516B, and the console reads “Hello world!” as shown at 514B.

Although not shown, it is notable that both the first client and the second client are able to interact with the debugger. As such, the view of the debugger at the first client 502 is a live debugger, and not simply a mirrored display of the second client. Moreover, an operation received through the first client may also be mirrored at the second client, in some embodiments.

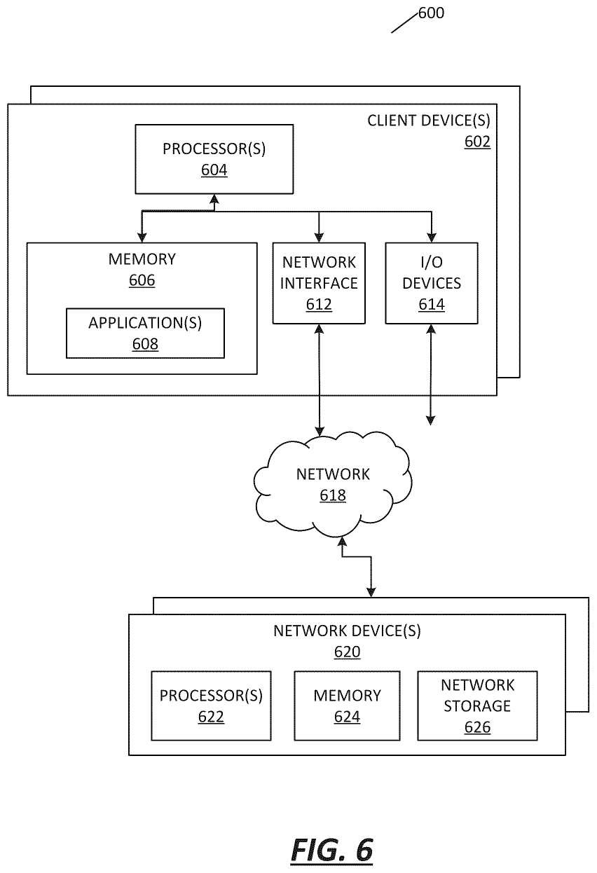

FIG. 6 shows an example of a hardware system for implementation of the multiplayer debugger in accordance with the disclosed embodiments. FIG. 6 depicts a network diagram 600 including a client computing device 602 connected to one or more network devices 620 over a network 618. Client device 602 may comprise a personal computer, a tablet device, a smart phone, network device, or any other electronic device which may be used to perform debugging operations on a computer program. The network 618 may comprise one or more wired or wireless networks, wide area networks, local area networks, enterprise networks, short range networks, and the like. The client computing device 602 can communicate with the one or more network devices 620 using various communication-based technologies, such as Wi-Fi, Bluetooth, cable connections, satellite, and the like. Users of the client devices 602 can interact with the network devices 620 to access services controlled and/or provided by the network devices 620.

Client devices 602 may include one or more processors 604. Processor 604 may include multiple processors of the same or different type, and may be configured to execute computer code or computer instructions, for example computer readable code stored within memory 606. For example, the one or more processors 604 may include one or more of a central processing unit (CPU), graphics processing unit (GPU), or other specialized processing hardware. In addition, each of the one or more processors may include one or more processing cores. Client devices 602 may also include a memory 606. Memory 606 may each include one or more different types of memory, which may be used for performing functions in conjunction with processor 604. In addition, memory 606 can include one or more of transitory and/or non-transitory computer readable media. For example, memory 606 may include cache, ROM, RAM, or any kind of computer readable storage device capable of storing computer readable code. Memory 606 may store various programming modules and applications 608 for execution by processor 604. Examples of memory 606 include magnetic disks, optical media such as CD-ROMs and digital video disks (DVDs), or semiconductor memory devices.

Computing device 602 also includes a network interface 612 and I/O devices 614. The network interface 612 may be configured to allow data to be exchanged between computing devices 602 and/or other devices coupled across the network 618. The network interface 612 may support communication via wired or wireless data networks. Input/output devices 614 may include one or more display devices, keyboards, keypads, touchpads, mice, scanning devices, voice or optical recognition devices, or any other devices suitable for entering or retrieving data by one or more client devices 602.

Network devices 620 may include similar components and functionality as those described in client devices 602. Network devices 620 may include, for example, one or more servers, network storage devices, additional client devices, and the like. Specifically, network device may include a memory 624, storage 626, and/or one or more processors 622. The one or more processors 622 can include, for example, one or more of a central processing unit (CPU), graphics processing unit (GPU), or other specialized processing hardware. In addition, each of the one or more processors may include one or more processing cores. Each of memory 624 and storage 626 may include one or more of transitory and/or non-transitory computer readable media, such as magnetic disks, optical media such as CD-ROMs and digital video disks (DVDs), or semiconductor memory devices. While the various components are presented in a particular configuration across the various systems, it should be understood that the various modules and components may be differently distributed across the network.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A system comprising:
one or more processors; and
a memory coupled to the one or more processors and comprising:
a computer program;
a debugger module; and
a debugger multiplexer configured to:
initiate a multiplayer debugger session for the computer program, wherein the multiplayer debugger session supports a plurality of client devices,
receive, from a first client device of the plurality of client devices, a debugger operation,
transmit the debugger operation to the debugger module,
determine an updated debugger state in accordance with the debugger operation, and
transmit the updated debugger state to a remainder of the plurality of client devices.

2. The system of claim 1, wherein the debugger multiplexer is further configured to cause a presentation of a user interface corresponding to the debugger session to update in accordance with the updated debugger state.

3. The system of claim 1, the memory further comprising:
a debugger adapter configured to abstract the debugger operation, wherein the debugger adapter provides multilanguage functionality based on the abstraction.

4. The system of claim 1, wherein the debugger multiplexer is further configured to:
manage a plurality of debugger multiplexer sessions comprising the multiplayer debugger session; and
transmit the updated debugger state to the remainder of the plurality of client devices in accordance based on an identification of the multiplayer debugger session among the plurality of multiplayer debugger sessions.

5. The system of claim 1, wherein the debugger multiplexer is further configured to transmit the updated debugger state in accordance with a determination that the debugger operation satisfies a share criteria.

6. The system of claim 1, wherein the debugger multiplexer is further configured to:
receive, from the first client device, a second debugger operation,
transmit the second debugger operation to the debugger module,
determine that the second debugger operation does not satisfy a share criterion, and
in accordance with the determination that the second debugger operation does not satisfy the share criterion, cause a debugger view to be updated at the first client device in accordance with the second debugger operation.

7. The system of claim 1, further comprising:
a debugger session manager configured to manage the debugger multiplexer and one or more additional debugger multiplexers, wherein each debugger multiplexer is associated with a multiplayer debugger session for the computer program.

8. A non-transitory computer readable medium comprising computer readable code executable by one or more processors to:
initiate a multiplayer debugger session for a computer program, wherein the multiplayer debugger session supports a plurality of client devices,
receive, from a first client device of the plurality of client devices, a debugger operation,
determine an updated debugger state in accordance with the debugger operation, and
transmit the updated debugger state to a remainder of the plurality of client devices in accordance with the remainder of the plurality of client devices belonging to the multiplayer debugger session.

9. The non-transitory computer readable medium of claim 8, further comprising computer readable code to:
cause a presentation of a user interface corresponding to the debugger session to update in accordance with the updated debugger state.

10. The non-transitory computer readable medium of claim 8, further comprising computer readable code to:
manage a plurality of debugger multiplexer sessions comprising the multiplayer debugger session; and
transmit the updated debugger state to the remainder of the plurality of client devices in accordance based on an identification of the multiplayer debugger session among the plurality of multiplayer debugger sessions.

11. The non-transitory computer readable medium of claim 8, further comprising computer readable code to:
receive, from the first client device, a second debugger operation,
transmit the second debugger operation to the debugger module,
determine that the second debugger operation does not satisfy a share criterion, and
in accordance with the determination that the second debugger operation does not satisfy the share criterion, cause a debugger view to be updated at the first client device in accordance with the second debugger operation.

12. The non-transitory computer readable medium of claim 8, wherein the multiplayer debug session comprises a primary debug session, and further comprising computer readable code to:
receive a request to begin a new debugger session for the program;
in response to receiving the request, initiate a secondary debugging session for the program.

13. The non-transitory computer readable medium of claim 12, wherein the computer readable code to initiate the secondary debugging session comprises computer readable code to:
clone the primary debugging session to generate a secondary debugging session;
initialize a secondary debugging proxy instance; and
synchronize the secondary debugging session state information to clients in the second debugging session.

14. The non-transitory computer readable medium of claim 12, further comprising computer readable code to:
provide a user selectable option to a new client device to join the primary debugging session or the second debugging session for the program.

15. A method comprising:
initiating a multiplayer debugger session for a computer program, wherein the multiplayer debugger session supports a plurality of client devices,
receiving, from a first client device of the plurality of client devices, a debugger operation,
determining an updated debugger state in accordance with the debugger operation, and
transmitting the updated debugger state to a remainder of the plurality of client devices in accordance with the remainder of the plurality of client devices belonging to the multiplayer debugger session.

16. The method of claim 15, further comprising:
causing a presentation of a user interface corresponding to the debugger session to update in accordance with the updated debugger state.

17. The method of claim 15, further comprising:
managing a plurality of debugger multiplexer sessions comprising the multiplayer debugger session; and
transmitting the updated debugger state to the remainder of the plurality of client devices in accordance based on an identification of the multiplayer debugger session among the plurality of multiplayer debugger sessions.

18. The method of claim 15, further comprising:
receiving, from the first client device, a second debugger operation,
transmitting the second debugger operation to the debugger module,
determining that the second debugger operation does not satisfy a share criterion, and
in accordance with the determination that the second debugger operation does not satisfy the share criterion, causing a debugger view to be updated at the first client device in accordance with the second debugger operation.

19. The method of claim 15, wherein the multiplayer debug session comprises a primary debug session, and further comprising computer readable code to:
receiving a request to begin a new debugger session for the program;
in response to receiving the request, initiating a secondary debugging session for the program.

20. The method of claim 19, wherein initiating the secondary debugging session comprises:
cloning the primary debugging session to generate a secondary debugging session;
initializing a secondary debugging proxy instance; and
synchronizing the secondary debugging session state information to clients in the second debugging session.
